(19) United States
(12) Patent Application Publication
(10) Pub. No.: US 2005/0056226 A1
(43) Pub. Date: Mar. 17, 2005

(54) Thermally assisted pet dish

(76) Inventor: Michael Joseph Ruggiero JR., Highland, NY (US)

Correspondence Address: Michael J. Ruggiero Jr., 20 Blossom Grove Ct., Highland, NY, 12528, US

(21) Appl. No.: 10/661,080

(22) Filed: Sep. 12, 2003

(51) Int. Cl. A01K 1/10

(52) U.S. Cl. 119/61.52

(57) ABSTRACT

A thermally assisted pet dish whereby a substance is either heated or frozen to assist in the prevention of spoilage, A easily removable non-skid ring allows access for the regeneration, replacement or substitution of the substance as needed and retains the bottom were the weight is evenly distributed such that the dish is not easily over turned. Inside the vessel the insulation is placed such that BTU's from the conditioning source or sources is redirected towards the refreshment and its longevity is dramatically increased by the prevention of the BTU's escape from within the vessel.

### BACKGROUND OF THE INVENTION

This invention pertains to pet dishes; it is generally known that pets need refreshments to sustain life; pet owners supply their pets with a variety of refreshments. Some refreshments are intended to be served warm while others to be served cold these refreshments are also subject to the environment which may alter the way refreshments need to be served. These refreshments if not consumed by the pet immediately can loose there peck nutritional value, or loose their refreshing quality making the refreshment undesirable by the pet or worse yet, spoil which can make the pet sick and promote disease. Pet owners combat this by continually changing the refreshment at close intervals. So, it becomes clear there is a need to thermally control refreshments in either direction over an extended period.

Known prior art in pet dishes includes U.S. Pat. Nos. 5,738,038; 6,230,653; 4,691,664; 4,798,173 and 4,899,693 while these devices fulfill their objectives they do not have the capability to assist in aiding the temperature of refreshments in either direction. With the use of insulation greatly improving the redirection of the BTU's released by conditioning sources and shielding the external shell of this invention it leaves the known concept of prior art and enters into its own, providing an economical way to extend the life of refreshments which are either hot or cold especially when a pet is housed outside of the home, in a remote area were electricity is not available to utilize other known prior art or when the pet may be known to chew electrical cords.

### SUMMARY OF THE INVENTION

The main objective of this invention, which will be described in greater detail later, is to control the temperature of refreshments served to pets for extended periods in either direction. The disadvantage in present known types of pet dishes is that they are designed to maintain cool or warm temperatures. It has not been proven, rendered obvious or strongly implied by prior art to achieve the combination.

In retrospect, before outlining the invention it is to be understood that this arrangement may be constructed various ways, with any combination of these components, with a multitude of materials, sizes, shapes, or colors, and the description, or terminology used, not be limiting, but to be taken in the true spirit of the invention especially by those skilled in the arts of manufacturing and or design capabilities.

To attain the objective the invention is comprised of a ridged shell, bowl like, made of stainless steel and or any other material capable of being formed to hold refreshment in a variety of shapes, able to be easily cleaned, capable of conducting heat readily, able to be built in variety of sizes based upon the pet's size or nutritional requirements and, may be constructed to be used independently of this invention for every day use. The bottom, made of plastic, or other suitable material, is also easily cleaned, and must be able to retain the temperature conditioning cartridges. The bottom is also, easily removable and is retained to the shell by means of a friction grip formed in a non-skid ring made from a rubber base, or suitable material. The grip and or the non-skid ring may also be formed into the bottom simplifying the construction process and eliminating parts. The pet dish also contains temperature conditioning cartridges or solids substances located within the cavity formed by the bottom, and the hollow of the exterior shell. Their size may also be adjusted, not only to the shell size, but to accommodate the regeneration means, therefore, they may come in mutable pieces, or in a another variation, the regeneration means may be incorporated within the shell and a fixed bottom eliminating the need for cartridges. Cartridges or solids may be regenerated, replaced, or substituted as needed and they may or may not be required to be removed from its shell depending upon how they are to be regenerated. The exterior of these cartridges may be made of plastics, pvc and or any suitable material which can be formed by known means and can withstand both heat and cold, and also easily cleaned. The basic contents of these cartridges, is a non-toxic water base, gel like substance made up of salts; to lower density, gums; as a thickening agent, dyes; to detect any leaks, urea; acts as temperature retardant, and sodium chloride; giving the liquid a lower density and the ability to absorb either heat or cold. These basic simple contents may be refined and or substituted with other chemicals or materials by those skilled in the art of chemical compositions and or manufacturing but, this substance allows for the basic transfer of BTU's in either direction over extended periods obtaining the objective of the invention. Because some materials are more susceptible to heat or cold transfer, mutable conditioning sources may be utilized; like conventional ice packs readily found on the market. They transfer cold very well, but most contain glycol; which may not be heated, so to achieve the objective another conditioning source is necessary. Certain solids such as stones, clays or other suitable materials retain heat and transfer it very well for this purpose, but they do not work as well for cooling, so by using mutable conditioning sources the objective of this invention is also achieved. Regeneration for these conditioning sources vary and may be, but not limited to; microwaves, ovens, freezers, or electricity, which ever is best suited for the material and or the regeneration means, and or for the desired conditioning temperature of hot or cold. The final component within the pet dish contributing towards the objective is the insulation which may, or may not be used depending upon the variation applied. The insulation is comprised of foam sandwiched between layers of pvc and or other suitable combinations of water proof materials and or gases, placed in between the conditioning cartridges, the shell, and the bottom, in another variation the insulation may be placed over the exterior shell. The insulation is used to redirect the BTU's from temperature assisting cartridges towards the refreshment and away from the outer shell or to shield the shell, which is exposed to the pet and its owner, promoting safety, while dramatically increasing the longevity of the refreshment being served, and assisting in the completion of the main objective of this invention.

### BRIEF DESCRIPTION OF THE DRAWINGS

The invention may be better understood and explained by the use of drawings they are:

FIG. 1 is a sectional view of the pet dish along any vertical line.

FIG. 2 is a top plan view of the dish.

### DESCRIPTION OF THE PREFERRED EMBODIMENT

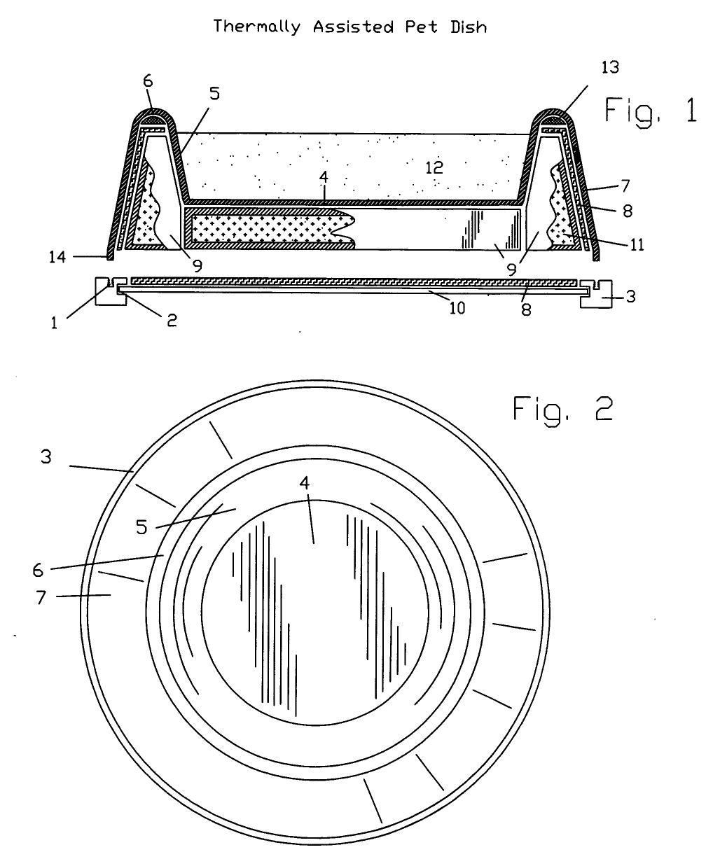

Referring to the drawings; FIG. 1 and FIG. 2 the preferred embodiment is being provided, But it is to be known that the invention may take various forms and sizes some of which are outlined in the summary of the invention. Referring now to the drawings FIG. 1 and FIG. 2 the exterior of the stainless steel shell is a continuous formed dish comprised of a outer wall 7 and a inner wall 5 which along with the bottom of the shell 4 forms a depression capable of holding pet refreshments 12. The shell is easily attached to the inventions bottom 10 by means of a rubber base, non-skid ring 3 and the extension of the shell 14 using a friction grip 1 formed into the non-skid ring 3. The bottom 10 is also attached to the non-skid ring 3 by sandwiching the vertical end of the bottom 10 into the, for mentioned ring 3 thereby completing the exterior shell. The interior of the previously described shell along with the bottom 10 forms and interior cavity which holds the temperature assisting cartridges 9 and the insulation 8 and 13, the insulation 8 is formed of foam, and is sandwiched between layers of pvc to protect it from condensation, the insulation 8, which shields the shell 7 and crown of the shell 6, from BTU transfer, also protecting the pet and owner, redirects the BTU's towards the refreshment 12. The insulation is placed between the cartridges 9 and the interior shell 7 and the crown 6 were insulation 13 is used to fill a void at the crown 6 and adhere the insulation 8 to the exterior shell. The insulation 8 is also used on the interior of the bottom 10 for the same reasons listed above. The temperature assisting cartridges 9 are also contained within the cavity formed by the interior of the shell and bottom 10 along with insulations 8, 13. The cartridges 9 are constructed of polyethylene and formed by any known blow molding process, they contain a gel like substance 11 comprised of the following basic ingredients; water, salts, dyes, urea, and sodium chloride. This substance allows the cartridges 9 BTU's to be regenerated in a multitude of ways, like freezers and microwaves, also in a variety of temperatures, primarily hot and cold. The sizes of the cartridges 9 are controlled by the size of the internal cavity mentioned previously, also containing the insulations 8 and 13, and the limitations set forth by the means of regeneration therefore the cartridges 9 may come in a multitude of sizes and or shapes, but the cartridges 9 must fit tightly against the interior faces of the bottom 4, and the interior shell 5 to assure the extended transfer of the BTU's from the cartridges 9 and the pet's refreshment 12. The cartridges 9, insulations 8 and 13, filling the cavity must also allow the bottom 10 to become fully engaged onto the shell at point 14 utilizing the ring 3, further containing the BTU's and completing the inventions objective.

1-10. (canceled)

11. A pet dish in which contents are thermally controlled by a conditioning source to aid in the longevity of the refreshment.

12. A pet dish as claimed in claim 11 in which multiple conditioning sources maybe present at the time of use to enhance the performance of the dish.

13. A pet dish as claimed in 11 in which the conditioning sources can be regenerated and may be made to accept either hot or cold.

14. A pet dish as claimed in 11 wherein said conditioning can be adjusted in size to accommodate means of regeneration.

15. A pet dish as claimed in 11 wherein conditioning sources is thermally insulated from the exterior environment while thermal energy is directed toward contents of said pet dish.

16. A pet dish as claimed in 11 in which the pet dish has non-skid and weight distribution properties to aid in keeping said dish upright.

17. A pet dish as claimed in 11 in which said dish can be used with or without said conditioning sources present.
